(19) United States
(12) Patent Application Publication
(10) Pub. No.: US 2013/0028642 A1
(43) Pub. Date: Jan. 31, 2013

(54) IMAGE FORMING APPARATUS

(71) Applicants: Yasutaka Yagi, Mishima-shi (JP); Yoshiro Saito, Boise, ID (US); Tomonori Shida, Mishima-shi (JP); Hiroyuki Seki, Numazu-shi (JP)

(72) Inventors: Yasutaka Yagi, Mishima-shi (JP); Yoshiro Saito, Boise, ID (US); Tomonori Shida, Mishima-shi (JP); Hiroyuki Seki, Numazu-shi (JP)

(73) Assignee: CANON KABUSHIKI KAISHA, Tokyo (JP)

(21) Appl. No.: 13/556,485

(22) Filed: Jul. 24, 2012

(30) Foreign Application Priority Data
Jul. 29, 2011 (JP) 2011-167331

(51) Int. Cl. G03G 15/16

(52) U.S. Cl. 399/313

(57) ABSTRACT

An image forming apparatus includes an image bearing member on which a toner image is to be formed; a transfer device for transferring the toner image carried on the image bearing member; and a rotationally movable endless transfer belt onto which the toner image is to be transferred or on which a transfer material onto which the toner image is to be transferred is to be conveyed. The transfer device includes a sheet member contacted to an inner peripheral surface of the transfer belt while being supported by a supporting member at an end thereof and includes an urging member for urging the sheet member against the transfer belt in contact to the sheet member. The urging member includes a projected portion projected toward the transfer belt at its downstream end portion more than at its upstream end portion with respect to a movement direction of the transfer belt.

### FIELD OF THE INVENTION AND RELATED ART

The present invention relates to an image forming apparatus, such as a printer or a copying machine, in which a toner image carried on an image bearing member is transferred onto an intermediary transfer member or a transfer material carried on a transfer material conveying member.

In a conventional electrophotography, there is an image forming apparatus in which the toner image is transferred from the image bearing member into a belt-like intermediary transfer member, i.e., an intermediary transfer belt, nipped between the image bearing member for carrying the toner image and a transfer roller. Further, there is an image forming apparatus in which a belt-like transfer material conveying member for conveying the transfer material, i.e., a transfer material conveying belt is nipped between the image bearing member and the transfer roller, and the toner image is transferred from the image bearing member onto the transfer material on the belt.

Here, a region where the transfer roller and the belt contact, i.e., a so-called transfer nip is important for ensuring a good transfer property and is required to be enlarged in order to suppress abnormal electric discharge. Here, the abnormal electric discharge refers to electric discharge which locally occurs in the case where a predetermined potential difference is generated in a space formed by the belt and the image bearing member. By this electric discharge, in some cases, the toner image on the intermediary transfer belt or the transfer material conveying belt is scattered.

However, in the case where the transfer roller is used, in order to increase the transfer nip region, there is only a method of increasing a roller diameter or decreasing a hardness of the transfer roller and therefore there is a limit when downsizing of the apparatus and manufacturing stability are taken into consideration. Based on these circumstances, in Japanese Laid-Open Patent Application (JP-A) 2007-156455 and JP-A 2008-310060, a method in which an electroconductive sheet member is provided as a transfer member in place of the transfer roller and is urged by an elastic urging member to cause the belt and the sheet member to hermetically contact to each other and thus a broad nip region is formed has been proposed.

However, in the case where a hermetic contact property of the sheet member to the belt is insufficient, an end portion of the sheet member is separated from the belt to narrow the transfer nip region. As a result, a sufficient transfer nip region cannot be ensured and thus there is a possibility that an image defect due to the abnormal electric discharge occurs.

### SUMMARY OF THE INVENTION

A principal object of the present invention is to provide an image forming apparatus capable of suppressing an image defect due to abnormal electric discharge by ensuring a hermetic contact property between an electroconductive sheet member as a transfer member and an intermediary transfer member or a transfer material conveying member.

According to an aspect of the present invention, there is provided an image forming apparatus comprising: an image bearing member on which a toner image is to be formed; a transfer device for transferring the toner image carried on the image bearing member; and a rotationally movable endless transfer belt onto which the toner image is to be transferred or on which a transfer material onto which the toner image is to be transferred is to be conveyed, wherein the transfer device includes a sheet member contacted to an inner peripheral surface of the transfer belt while being supported by a supporting member at an end thereof and includes an urging member for urging the sheet member against the transfer belt in contact to the sheet member, and wherein the urging member includes a projected portion projected toward the transfer belt at its downstream end portion more than at its upstream end portion with respect to a movement direction of the transfer belt.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of an image forming apparatus according to an embodiment of the present invention.

Parts (a) to (c) of FIG. 2 are schematic views for illustrating an example of a primary transfer member, wherein (a) is a schematic view for illustrating a relation among the primary transfer member, a photosensitive drum and an intermediary transfer belt, (b-1) is a side view of an example of an urging member constituting the primary transfer member, (b-2) is a perspective view of the urging member of (b-1), and (c) is a side view of another example of the urging member.

Parts (a) to (c) of FIG. 3 are schematic views for illustrating an example of a primary transfer member of Comparative Embodiment, wherein (a) is a schematic view for illustrating a relation among the primary transfer member, a photosensitive drum and an intermediary transfer belt, (b) is a side view of an urging member constituting the primary transfer member, and (c) is a perspective view of the urging member of (b).

FIG. 4 is a schematic view for illustrating another example of the primary transfer member.

Parts (a) to (c) of FIG. 5 are schematic views for illustrating another example of the primary transfer member, wherein (a) is a schematic view for illustrating a relation among the primary transfer member, a photosensitive drum and an intermediary transfer belt, (b) is a side view of another example of an urging member constituting the primary transfer member, and (c) is a perspective view of the urging member of (b).

Parts (a) to (c) of FIG. 6 are schematic views for illustrating another example of the primary transfer member, wherein (a) is a schematic view for illustrating a relation among the primary transfer member, a photosensitive drum and an intermediary transfer belt, (b) is a side view of another example of an urging member constituting the primary transfer member, and (c) is a perspective view of the urging member of (b).

FIG. 7 is a schematic view for illustrating another embodiment of the image forming apparatus according to the present invention.

### DESCRIPTION OF THE PREFERRED EMBODIMENTS

Hereinbelow, embodiments for carrying out the present invention will be specifically described with reference to the drawings. However, dimensions, materials, shapes, relative arrangements and the like of constituent elements described in the following embodiments should be appropriately modified depending on constitutions and various conditions of image forming apparatuses to which the present invention is applied. Therefore, the scope of the present invention is not limited thereto unless otherwise specified.

The image forming apparatus according to the present invention will be described below with reference to the drawings.

### First Embodiment

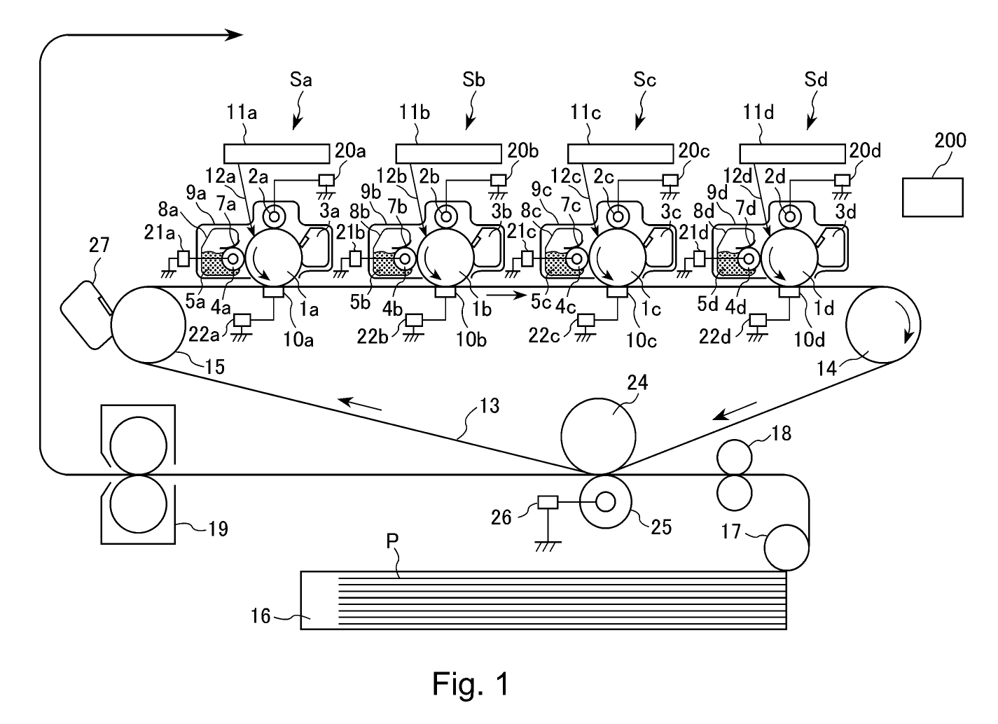

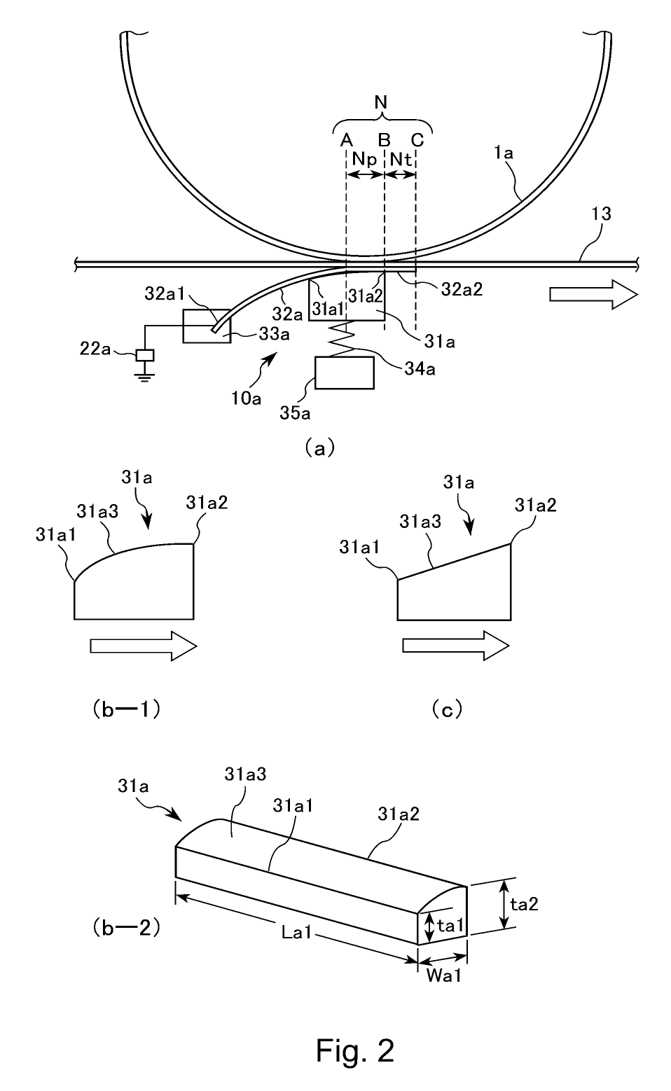

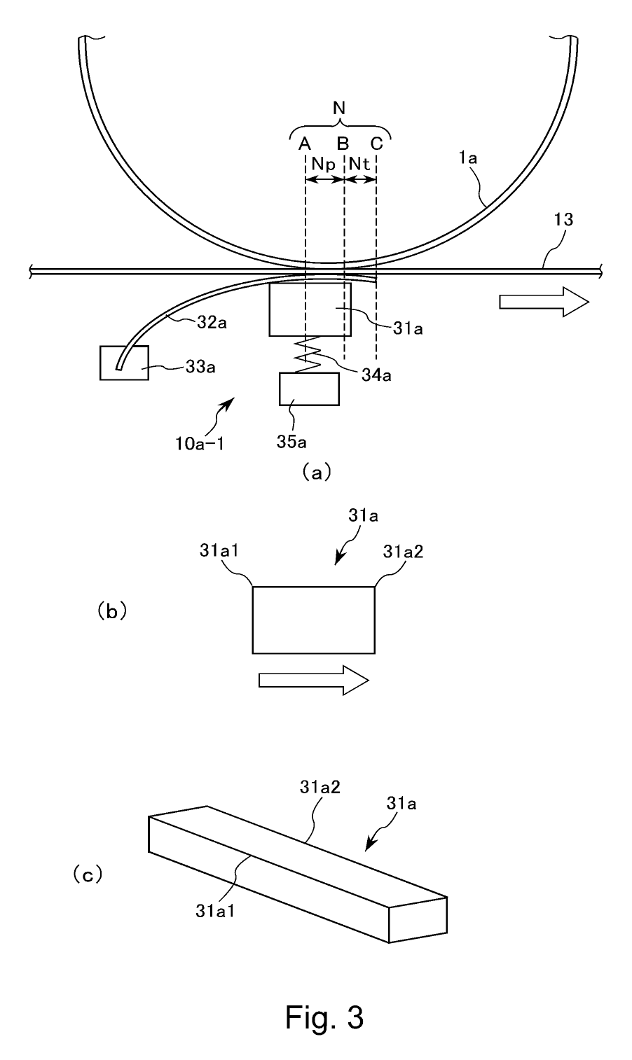

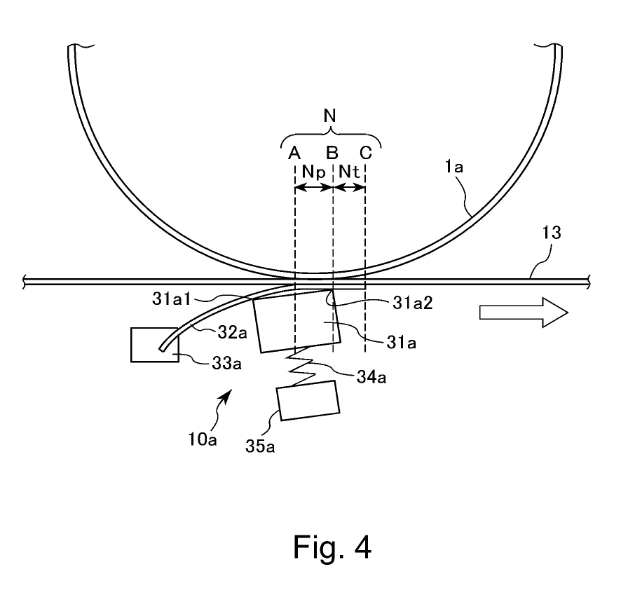

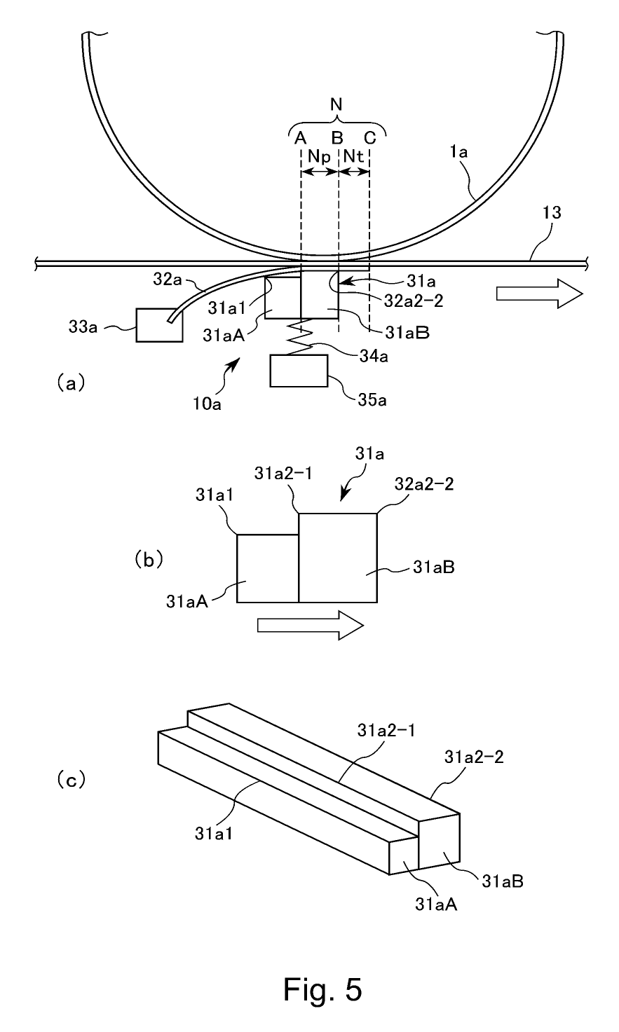

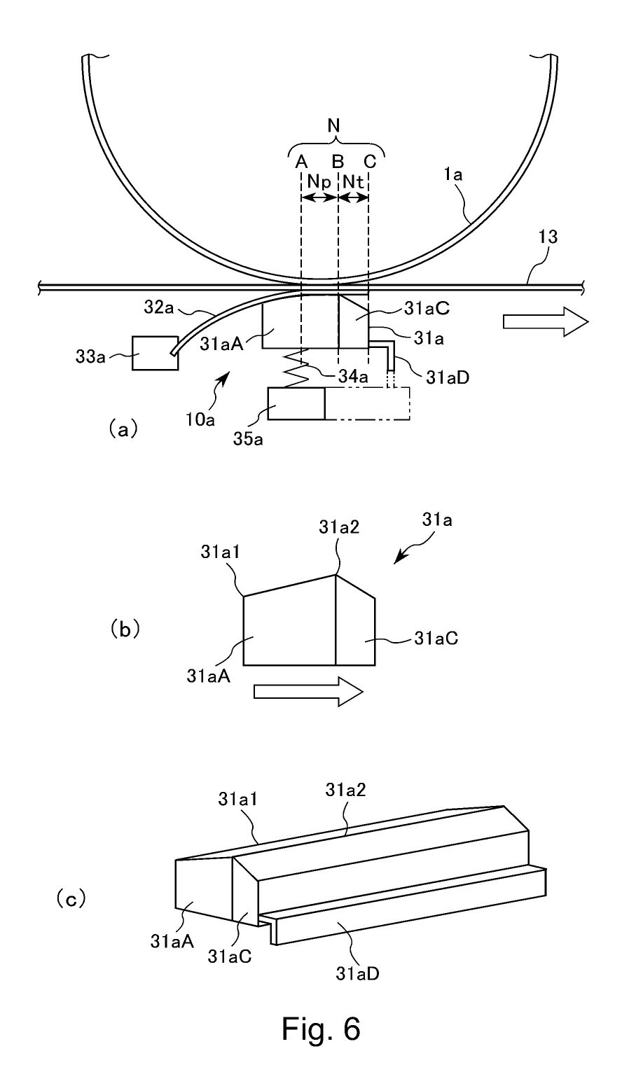

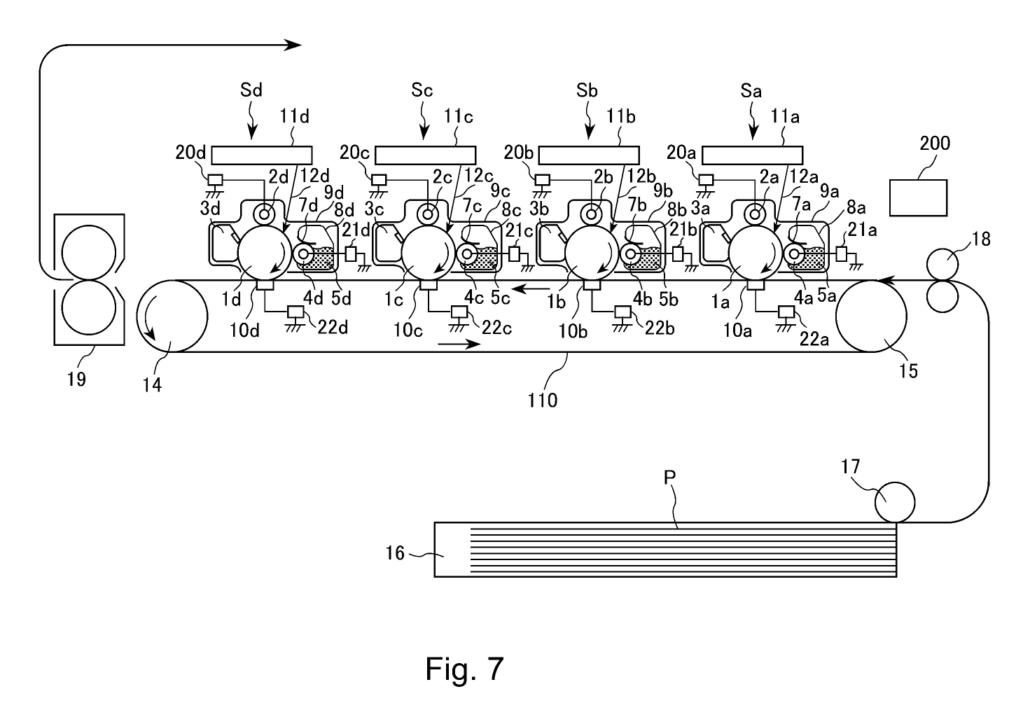

FIG. 1 shows a schematic illustration of a multi-color image forming apparatus, as an example of the image forming apparatus according to the present invention, including a plurality of image forming portions (stations).

The image forming apparatus in this embodiment includes four stations (Sa, Sb, Sc, Sd), in which a first station Sa is for yellow (Y), a second station Sb is for magenta (M), a third station Sc is for cyan (C), and a fourth station Sd is for black (K). The first station Sa includes an OPC photosensitive drum 1a as an image bearing member which is rotatably carried. At a periphery of the photosensitive drum 1a, a charging roller 2a as a charging device, a cleaning unit 3a as a cleaning device for removing a transfer residual toner on the photosensitive drum 1a, and a developing unit 8a as a developing device. The developing unit 8a includes a developing sleeve 4a, a non-magnetic one-component toner 5a, and a developer applying blade 7a. The above-described members of the photosensitive drum 1a, the charging roller 2a, the cleaning unit 3a, and the developing unit 8a constitute a process cartridge 9a of an integral type.

An exposure device 11 is constituted by a scanner unit for scanning the photosensitive drum la with laser light through a polygonal mirror and irradiates the surface of the photosensitive drum la with scanning beam 12a modulated on the basis of an image signal. Further, the charging roller 2a is connected to a developing power source 21a as a voltage supplying device 20a which is a voltage supplying device to the charging roller 2a. Further, a primary transfer member 10a as a primary transfer means which will be specifically described later is connected to a primary transfer power source 22a as a voltage supplying device to the primary transfer member 10a, and a secondary transfer roller 25 is connected to a secondary transfer power source 26.

Next, an image forming operation on the photosensitive drum la will be described. In this embodiment, an endless belt 13 as an intermediary transfer member (hereinafter referred to as an intermediary transfer belt) is provided under the four stations Sa to Sd. The intermediary transfer belt 13 is stretched around a driving roller 14, a tension roller 15 and a secondary transfer opposite roller 24 and is rotationally moved in an arrow direction.

When the image forming operation is started, the photosensitive drums 1a to 1d, the intermediary transfer belt 13, and the like start their rotations in directions indicated by arrows at predetermined process speeds. The photosensitive drum 1a is uniformly charged to a negative polarity by the charging roller 2a and then, on the photosensitive drum 1a, an electrostatic latent image in accordance with image information is formed by the scanning beam 12a from the exposure device 11.

A toner 5a in the developing unit 8a is charged to the negative polarity by the developer applying blade 7a and is applied onto the developing sleeve 4a. Then, to the developing sleeve 4a, a bias is supplied from a developing bias power source 21a, and when the photosensitive drum 1a is rotated and the electrostatic latent image formed on the photosensitive drum 1a reaches the developing sleeve 4a, the electrostatic latent image is visualized by the toner 5a of the negative polarity. As a result, a toner image of a first color (Y in this embodiment) is formed on the surface of the photosensitive drum 1a. Incidentally, also the second to fourth stations Sb and Sd have the same constitution as and perform the same operation as those of the first station Sa, so that toner images of second to fourth colors (M, C and K in this embodiment) are formed on the surfaces of the respective photosensitive drums 1b to 1d. Therefore, the image forming operations of the second to fourth stations Sb to Sd will be omitted from description.

The intermediary transfer belt 13 is, as shown in FIG. 1, disposed so as to be contacted to all the four photosensitive drums 1a to 1d.

Next, a transfer operation will be described. The intermediary transfer belt 13 is, as described above, movable supported by three rollers, as its stretching member, consisting of the secondary transfer opposite roller 24, the driving roller 14, and the tension roller 15, and is configured to be held under a proper tension. The intermediary transfer belt 13 is moved at the substantially same speed as and in the same direction as those of the photosensitive drums 1a to 1d by driving the driving roller 14. Further, the intermediary transfer belt 13 is rotationally moved in an arrow direction, and the primary transfer member 10a is disposed opposite to the photosensitive drum 1a with respect to the intermediary transfer belt 13. In the following, “upstream” and “downstream” refer to those with respect to a movement direction of the intermediary transfer belt 13.

As is understood from the above, at a periphery of the intermediary transfer belt 13 and at opposing portions of the photosensitive drums 1a to 1d, the primary transfer members 10a to 10d are disposed correspondingly to the photosensitive drums 1a to 1d, respectively. The electrostatic latent image by the exposure is formed on each of the photosensitive drums 1a to 1d while delaying a writing signal from a controller 200 with certain timing for each color depending on a distance between adjacent primary transfer positions for the respective colors. Then, to the primary transfer members 10a to 10d, voltages of an opposite polarity (positive in this embodiment) to the charge polarity of the toner images are applied by the primary transfer voltage sources 22a to 22d, respectively. By the above steps, the respective color toner images are primary-transferred successively onto the intermediary transfer belt 13, so that multiplex toner images (multiplex images) are formed on the intermediary transfer belt 13.

Thereafter, in synchronism with the formation of the electrostatic latent image by the exposure, a transfer material P as a recording material stacked in a transfer material cassette 16 is picked up by a sheet feeding roller 17 and is conveyed to registration rollers 18 by unshown conveying rollers. Then, the transfer material P is conveyed to a contact portion formed between the intermediary transfer belt 13 and the secondary transfer roller (secondary transfer means) 25 by the registration rollers 18 in synchronism with the toner images on the intermediary transfer belt 13. Thereafter, to the secondary transfer roller 25 connected, a voltage of an opposite polarity (positive in this embodiment) to the toner charge polarity of the toner is applied from the secondary transfer voltage source 26, so that the multiplex four color toner images carried on the intermediary transfer belt 13 are collectively secondary-transferred onto the transfer material P.

Incidentally, in this embodiment, as the secondary transfer roller 25, a roller of 18 mm in outer diameter prepared by coating a nickel-plated steel rod of 8 mm in outer diameter with a sponge foam member of NBR adjusted to 10⁸ Ω.cm in volume resistivity and 5 mm in thickness was used. Further, the secondary transfer roller 25 was disposed so that it was contacted to the intermediary transfer belt 13 at a linear pressure of about 5-15 g/cm and was rotated at the substantially same speed as and in the same direction as those of the intermediary transfer belt 13 with respect to the movement direction of the intermediary transfer belt 13.

On the other hand, after the secondary transfer is completed, transfer residual toner remaining on the intermediary transfer belt 13 and paper powder generated by conveying the transfer material P are removed and collected from the surface of the intermediary transfer belt 13 by a belt cleaning device 27 disposed in contact with the intermediary transfer belt 13. Incidentally, in the image forming apparatus in this embodiment, as the belt cleaning device 27, a cleaning blade formed of an urethane rubber or the like and having elasticity was used. Further, the transfer material P after the completion of the secondary transfer is conveyed into a fixing means 19 and is subjected to fixation of the toner images and then is discharged to the outside of the image forming apparatus as an image-formed product (print or copy). Incidentally, the intermediary transfer belt 13 is formed of polyimide (PI) in a thickness of 100 μm to have a volume resistivity of 10¹⁰ Ω.cm.

As the driving roller 14 as a stretching member, a roller of 25 mm in outer diameter prepared by coating a core metal of aluminum with a 1.0 mm-thick EPDM rubber in which carbon black is dispersed as an electroconductive agent to have a volume resistivity of 10⁴ Ω.cm is used. The tension roller 15 as the stretching member is formed with a metal rod of aluminum to have an outer diameter of 25 mm, and tension if 19.6 N on each side, i.e., 39.2 N as a total pressure. As the secondary transfer opposite roller 25 as a stretching member, a roller of 25 mm in outer diameter prepared by coating a core metal of aluminum with a 1.5 mm-thick EPDM rubber in which carbon black is dispersed as an electroconductive agent to have a volume resistivity of 10⁴ Ω.cm is used.

In the following, a feature of this embodiment will be described. Parts (a) to (c) of FIG. 2 are enlarged sectional views of respective portions of the primary transfer portion of the first station Sa. Other stations have the same constitution as that of the first station Sa and therefore will be omitted from description. The primary transfer member 10a includes, as shown in (a) of FIG. 2, an urging member 31a and a flexible sheet member 32a. One end 32a1 of the sheet member 32a is supported by a supporting member 33a and a free end 32a2 as the other end is provided with a moderate curve and is sandwiched between the intermediary transfer belt 13 and the urging member 31a while being contacted to an inner surface of the intermediary transfer belt 13.

Specifically, in this embodiment, as the sheet member 32a, a resinous sheet having a volume resistivity of 10⁶ Ω.cm under application of a voltage of 50 V is used. In this embodiment, as the sheet member 32a, a vinyl acetate sheet is used but it is also possible to use polycarbonate (PC), Pvdf, PET, polyimide (PI), polyethylene (PE), polyamide (PA), ultra high molecular weight polyethylene, and the like. With respect to the thickness, 30 μm to 500 μm is desirable. In this embodiment, the sheet member 32a of 150 μm in thickness is used. This is because in the case where the sheet member in a thickness out of the above range is used, the contact by rigidity of the sheet member 32a cannot be effected. In the case where the thickness is less than 30 μm, the rigidity is remarkably lowered and the sheet member is slidable to cause deformation (crease), so that an image defect is liable to occur. Further, in the case where the thickness is more than 500 μm, the rigidity is excessively high and thus the sheet member cannot form the moderate curve, so that it becomes difficult to ensure a transfer nip region.

Further, to the sheet member 32a, the primary transfer power source 22a is connected, and a voltage of 500 V is applied during an image forming operation. Further, the urging member 31a is held by a base 35a as a holding member via an urging spring 34a in this embodiment and is urged toward the photosensitive drum la with the total pressure of 9.8 N. The supporting member 33a of the sheet member 32a and the holding member 31a of the urging member 31a can also be constituted integrally as desired.

As the urging member 31a, an elastic member, of an insulating material in a foam urethane sponge shape, which is 2 mm in upstream side thickness (short side) (ta1), 3 mm in downstream side thickness (long side) (ta2), 4 mm in width (wa1) and 230 mm in length (La1) with respect to a direction perpendicular to a direction of the width (wa1). The urging member 31a has a hardness of 30 degrees in terms of ASKER C hardness under a load of 500 gf. In this embodiment, as a material for the urging member 31a, the foam urethane is used but it is also possible to use a rubber material such as epichlorohydrin rubber, NBR (nitrile rubber) or EPDM (ethylene-propylene-diene rubber).

Here, nip regions will be described. First, herein, the sum of regions of two types consisting of a physical nip region Np and a downstream tension nip region Nt which are described below is referred to as a transfer nip region N.

The physical nip region Np is a region where three members consisting of the photosensitive drum 1a, the intermediary transfer belt 13 and the sheet member 32a contact in (a) of Figure, i.e., a region between boundary positions A and B. From the sheet member 32a to which the voltage of 500 V is applied, positive electric charges are injected through the physical nip region Np to constitute carrying electric charges of the toner transferred from the intermediary transfer belt 13 onto the intermediary transfer belt 13, so that the primary transfer is effected.

Further, the downstream tension nip region Nt is a region, between boundary positions B and C, where the intermediary transfer belt 13 and the sheet member 32a contact. The downstream tension nip region Nt is a region where the photosensitive drum 1a does not contact the intermediary transfer belt 13. As described above, the positive electric charges injected at the physical nip region Np principally constitute the toner carrying electric charges on the intermediary transfer belt 13. On the other hand, the excessive positive electric charges which are not used as the toner carrying electric charges are returned to the sheet member 32a by circulation of the electric charges at the downstream tension nip region Nt. By this action, an occurrence of abnormal electric discharge between the photosensitive drum la and the intermediary transfer belt 13 at a downstream portion of the transfer nip region N can be suppressed.

Therefore, when the downstream tension nip region Nt cannot be ensured sufficiently, i.e., when close (intimate) contactness between the intermediary transfer belt 13 and the sheet member 32a is not sufficient, the excessive positive electric charges remain on the surface of the intermediary transfer belt 13 and thus an intermediary transfer belt surface potential at the downstream portion of the transfer nip region N is increased, so that the abnormal electric discharge occurs between the intermediary transfer belt 13 and the photosensitive drum 1a occurs and thus the image defect is caused.

A measuring method of the above-described boundary positions A, B and C will be described below. With respect to the boundary position B formed by the photosensitive drum la and the intermediary transfer belt 13, the belt drive is stopped and the photosensitive drum la is rotated in a state in which the toner image is present on the intermediary transfer belt 13. At this time, the toner image is removed only in the region where the photosensitive drum 1a and the intermediary transfer belt 13 contact and therefore the measurement of the boundary positions A and D can be performed by measuring its downstream positions.

Incidentally, when the measuring method is based on the same concept, e.g., a method in which the intermediary transfer belt 13 is marked (colored) with a vermilion ink pad, a Magic Marker or the like and its removal portion is measured may also be employed.

With respect to the boundary position A formed by the intermediary transfer belt 13 and the sheet member 32a, it is required to be considered that the boundary position A is a contact point between the flexible sheet member 32a and the intermediary transfer belt 13. In addition, influences of a frictional force by the rotational drive of the intermediary transfer belt 13 and the electrostatic attraction force by the voltage application to the sheet member 32a are required to be taken into consideration. Therefore, when the intermediary transfer belt 13 is rotated in a state in which the bias (voltage) is applied to the sheet member 32a, the boundary position A is measured on the basis of the contact region formed by the sheet member 32a and the intermediary transfer belt 13.

With respect to the boundary position C formed by the intermediary transfer belt 13 and the sheet member 32a, a contact point is measured through a cross section observation.

From the respective boundary positions (lines) obtained by the above-described measurement, the physical nip region Np (between A and B) was 2.5 mm and the downstream tension nip region Nt (between B and C) was 0.5 mm. Incidentally, with respect to the second to fourth stations Sb to Sd, the same constitution as that of the first station Sa is employed and therefore will be omitted from description.

In this embodiment, an upper surface of the urging member 31a is, as shown in (b-1) and (b-2) of FIG. 2, projected toward the intermediary transfer belt 13 at its downstream side end portion 31a2 more than at its upstream side end portion 31a1. In this embodiment, the projected portion formed at the downstream end portion 31a2 is present within the transfer nip region N. As a result, at the projected portion 31a2, the sheet member 32a is urged upward, so that the sheet member 32a is intimately contacted to the intermediary transfer belt 13 to form the downstream tension nip region Nt (between B and C). By ensuring the downstream tension nip region Nt, the above-described electric charge circulating action is exerted, so that it is possible to prevent the occurrence of the image defect due to the abnormal electric discharge. In (b-1) of FIG. 2, an edge line 31a3 connecting upstream and downstream edges 31a1 and 31a2 of the elastic member 31a had an arcuate shape following a moderate curve of the sheet member 32a. However, even when the edge line 31a3 connecting the both edges 31a1 and 31a2 have a linear shape as shown in (b-2) of FIG. 2, the downstream edge 31a2 is projected toward the intermediary transfer belt 13, so that the same effect can be achieved.

### Evaluation of First Embodiment

In order to check the effect of the image forming apparatus in this embodiment, by using the image forming apparatus of 100 mm/sec in process speed, evaluation was performed with respect to an abnormal electric discharge image at an initial stage and after sheet passing of 10,000 sheets in each of this embodiment and Comparative Embodiment 1. Incidentally, a sheet passing durability test was conducted by using paper (“Xerox 4024”, mfd. by Xerox Corp.; basis weight=75 g/m², and an image after passing of 10,000 sheets for accelerating toner deterioration by the durability test was evaluated.

In the constitution in this embodiment, the abnormal electric discharge image was not generated and was good from the initial stage to after the sheet passing of 10,000 sheets.

### Comparative Embodiment 1

Parts (a) to (c) of FIG. 3 are schematic views for illustrating Comparative Embodiment 1. In Comparative Embodiment 1, as shown in (a) of FIG. 3, a primary transfer member 10a-1 has the same constitution as that of First Embodiment except that only a shape of an urging member 31a is different. Therefore, general structure and operation of the primary transfer member 10a-1 are the same as those in First Embodiment and will be omitted from detailed description.

In Comparative Embodiment 1, the free end portion of the sheet member 32a supported by the sheet member supporting member 33a at another end portion of the sheet member 32a is urged by the urging member 31a urged against the sheet member 32a by the spring member 34a, so that the belt 13 is urged toward the image bearing member 1a.

The shape of the urging member 31a which urges the sheet member 32a is a rectangular parallelopiped shape and therefore in some cases, the close contactness between the sheet member 32a and the belt 13 is insufficient as the region between B and C in FIG. 3 as a result that the degree of close contactness is inferior to rigidity (stiffness) of the sheet member 32a. As a result, in some cases, a sufficient downstream tension nip region (between B and C) was not capable of being ensured. Incidentally, also the second to fourth stations Sb to Sd have the same constitution as that of the first station Sa and therefore will be omitted from description.

Next, an evaluation result will be described. With respect to Comparative Embodiment 1, in the downstream tension nip region Nt (between B and C), the intermediary transfer belt 13 and the sheet member 32a cannot intimately contact in some cases and thus the electric charge circulating function is not performed, so that it was confirmed that the abnormal electric discharge image was generated.

Incidentally, even in the case of the rectangular parallelopiped as shown in (b) and (c) of FIG. 3, by including a bearing surface of the spring member 34a as shown in FIG. 4, the upper surface 31a3 of the urging member 31a opposing the sheet member 32a is not parallel to the belt 13. That is, by rotating the holding member 35a which holds the urging member 31a via the spring member 34a, the upper surface 31a3 of the urging member 31a is not parallel to the belt 13, so that the downstream portion 31a2 is projected and thus it is possible to obtain the same effect as that in the constitution of FIG. 2.

From the above, as in First Embodiment, the shape of the top surface of the elastic member 31a is such that the downstream side end portion 31a2 is projected toward the intermediary transfer belt 13 more than the upstream side end portion 31a1 and therefore the intermediary transfer belt 13 and the sheet member 32a can be closely contacted to each other with no gap in the downstream tension nip region Nt (between B and C). As a result, in the downstream tension nip region Nt, the circulating function of the electric charges injected from the sheet member 32a is performed, so that it is possible to suppress the occurrence of the image defect due to the abnormal electric discharge.

### Second Embodiment

A basic constitution of an image forming apparatus to which the present invention is applied in this embodiment is the same as that in First Embodiment and therefore elements or portions having the same or corresponding functions and constitutions as those in First Embodiment are represented by the same reference numerals or symbols and will be omitted from detailed description.

Second Embodiment is characterized in that the urging member 31a is constituted by two members. This feature will be described below.

The urging member 31a used in this embodiment is constituted by the two members as shown in (a), (b) and (c) of FIG. 5. An upstream side member 31aA has the same hardness as that in First Embodiment, i.e., 30 degrees in terms of Asker C hardness under the load of 500 gf. On the other hand, a downstream side member 31aB has a high hardness of 50 degrees in terms of Asker C hardness under the load of o500 gf. The downstream side member 31aB is used in the physical nip roller Np (between A and B) and is contacted to the sheet member 32a toward the photosensitive drum la and therefore when a durability test proceeds, a shape change thereof such as permanent deformation can occur. In this embodiment, in order to prevent the permanent deformation after the durability test, the hardness of the downstream side member 31aB is made high. The upstream side member 31aA is contacted to the sheet member 32a at its corner 31a1 and thus there is a possibility that it damages the sheet member 32a when its hardness is excessively high, and therefore may preferably have a low hardness.

The urging member 31a constituted by the two members is prepared by providing the upstream side member 31aA and the downstream side member 31aB as different members but can also be prepared by integrally molding the upstream side member 31aA and the downstream side member 31aB.

Even in the case of the urging member 31a constituted by the two members as in this embodiment, by the presence a portion 31a2 (31a2-1, 31a2-2) at the downstream side portion projected more than at the upstream side end portion 31a, the sheet member 32a is pushed up as shown in (a) of FIG. 5. That is, in this embodiment, the edge line of the urging member 31a is stepwisely increased (stepped) from the upstream side 31a toward the downstream side end portion 31a2-2, so that the sheet member 32a is urged against the belt 13. As a result, the intermediary transfer belt 13 and the sheet member 32a are closedly contacted and thus the downstream tension nip region Nt (between B and C) can be ensured, so that it is possible to prevent the occurrence of the image defect due to the abnormal electric discharge.

Further, as the urging member 31a constituted by the two members, as shown in (a), (b) and (c) of FIG. 6, the urging member 31a can be constituted by two members, i.e., an urging member 31aA, located in the upstream side of the intermediary transfer belt conveyance direction, for urging the sheet member 32aand a downstream side inclination preventing member 31aC as a regulating member for regulating inclination of the urging member 31aA.

The urging member 31aA has the same constitutions that of the urging member 31a shown in FIG. 2. Further, the inclination preventing member 31aC is disposed at a position downstream of the urging member 31aA with respect to the intermediary transfer belt conveyance direction to performing a function of preventing the urging member 31aA located in the upstream side from being inclined toward the downstream side with respect to the intermediary transfer belt conveyance direction.

Also in the constitution of FIG. 6, a downstream portion 31a2 of the urging member 31aA is projected toward the belt 13 and thus the downstream tension nip region Nt (between B and C) can be ensured, so that the same effect as that described in First Embodiment can be obtained.

Further, the inclination preventing member 31aC can be formed of the same material as that for the urging member 31aB in the constitution of FIG. 5 and may also be formed of another plastic resin or the like. Further, the inclination preventing member 31aC is prepared as a different member from the urging member 31aA but may also be molded integrally with the urging member 31aA.

Further, the inclination preventing member 31aC may also be, in the case where it is prepared as the different member from the urging member 31aA, as shown in (a) and (c) of FIG. 6, molded integrally with a support member 31aD, and this support member 31aD can also be mounted on the urging member holding member 35a.

In the above-described First and Second Embodiments, the image forming apparatus of the present invention was described as the color image forming apparatus of the intermediary transfer type.

However, the present invention is similarly applicable to a so-called image forming apparatus of a direct transfer type, as shown in FIG. 7, in which a transfer material conveying member, which is an endless belt member for conveying a transfer material P, i.e., a transfer material conveying belt 110 is provided in place of the intermediary transfer belt 13. The image forming apparatus of the direct transfer type has a constitution in which toner images formed on surfaces of photosensitive drums 1 (1a to 1d) are successively transferred directly onto the transfer material P conveyed to respective image forming portions by the transfer member conveying belt to form (record) a color image. Such an image forming apparatus is well known by a person ordinarily skilled in the art and therefore will be omitted from further description. Further, the present invention is also applicable to a monochromatic image forming apparatus.

Further, in the above-described embodiments, the printer is used as the example of the image forming apparatus but the present invention is not limited thereto. For example, the image forming apparatus of the present invention may also be other image forming apparatuses, such as a copying machine, a facsimile machine and a multi-function machine having a combination of these functions. By applying the present invention to these image forming apparatuses, a similar effect can be achieved.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 167331/2011 filed Jul. 29, 2011, which is hereby incorporated by reference.

What is claimed is:

1. An image forming apparatus comprising:
an image bearing member on which a toner image is to be formed;
a transfer device for transferring the toner image carried on said image bearing member; and
a rotationally movable endless transfer belt onto which the toner image is to be transferred or on which a transfer material onto which the toner image is to be transferred is to be conveyed,
wherein said transfer device includes a sheet member contacted to an inner peripheral surface of said transfer belt while being supported by a supporting member at an end thereof and includes an urging member for urging said sheet member against said transfer belt in contact to said sheet member, and
wherein said urging member includes a projected portion projected toward said transfer belt at its downstream end portion more than at its upstream end portion with respect to a movement direction of said transfer belt.

2. An apparatus according to claim 1, wherein said sheet member supported by said supporting member at its upstream end with respect to the movement direction of said transfer belt and has a free end at its downstream end with respect to the movement direction of said transfer belt.

3. An apparatus according to claim 1, wherein said sheet member is contacted to the inner peripheral surface of said transfer belt in a transfer nip region consisting of a physical nip region where said image bearing member, said transfer belt and said sheet member contact and a downstream nip region, located downstream of the physical nip region, where said transfer belt and said sheet member contact.

4. An apparatus according to claim 3, wherein said projected portion is located in the transfer nip region with respect to the movement direction of said transfer belt.

5. An apparatus according to claim 1, wherein said urging member has an arcuate shape so that its height toward said transfer belt is increased from the downstream end portion to the upstream end portion.

6. An apparatus according to claim 1, wherein said urging member has a linear shape so that its height toward said transfer belt is increased from the downstream end portion to the upstream end portion.

7. An apparatus according to claim 1, wherein said urging member has a stepped shape so that its height toward said transfer belt is increased from the downstream end portion to the upstream end portion.

8. An apparatus according to claim 3, wherein said urging member is a rectangular parallelopiped supported by a supporting portion, and
wherein the supporting portion supports the rectangular parallelopiped so that its surface opposing the inner peripheral surface of said transfer belt is inclined with respect to the inner peripheral surface of said transfer belt in the transfer nip region.

9. An apparatus according to claim 3, wherein said urging member includes a first member and a second member located upstream of the first member with respect to the movement direction of said transfer belt, and
wherein the first member is higher in hardness than the second member.

10. An apparatus according to claim 9, wherein the first member urges said transfer belt in the physical nip region with respect to the movement direction of said transfer belt.

11. An apparatus according to claim 3, wherein said urging member includes a first member and a second member located upstream of the first member with respect to the movement direction of said transfer belt, and
wherein the first member is projected toward said transfer belt more than the second member.

12. An apparatus according to claim 1, further comprising a regulating member, provided downstream of said urging member with respect to the movement direction of said transfer belt, for regulating a position of said urging member with respect to the movement direction.

13. An apparatus according to claim 1, wherein said transfer belt is an intermediary transfer belt onto which the toner image is transferred from said image bearing member.

14. An apparatus according to claim 1, wherein said transfer belt is a transfer material conveying belt for conveying a transfer material onto which the toner image is to be transferred from said image bearing member.

15. An apparatus according to claim 1, wherein a plurality of image bearing members and a plurality of transfer devices are provided, and
wherein a color toner images is transferable onto the transfer material.
